(19) United States
(12) Patent Application Publication
(10) Pub. No.: US 2026/0226239 A1
(43) Pub. Date: Aug. 6, 2026

(54) METHOD FOR MODIFYING LOW ELECTRIC FIELD REFRIGERATION PERFORMANCE OF POLYVINYLIDENE FLUORIDE FERROELECTRIC POLYMER AND APPLICATION THEREOF

(71) Applicant: SHANGHAI JIAOTONG UNIVERISTY, Shanghai (CN)

(72) Inventors: Xiaoshi QIAN, Shanghai (CN); Shanyu ZHENG, Shanghai (CN)

(73) Assignee: SHANGHAI JIAO TONG UNIVERSITY, Shanghai (CN)

(21) Appl. No.: 18/842,057

(22) PCT Filed: May 23, 2022
(86) PCT No.: PCT/CN2022/094541

§ 371 Date: Aug. 30, 2024

(30) Foreign Application Priority Data
Jun. 9, 2021 (CN) 202110642335.3

(51) Int. Cl. C08J 3/09

(52) U.S. Cl. CPC C08J 3/096; C08J 2327/16

(57) ABSTRACT

A method for modifying the low electric field refrigeration performance of a polyvinylidene fluoride ferroelectric polymer and an application thereof. A polyvinylidene fluoride multi-copolymer solution is reacted with an organic base to obtain a polyvinylidene fluoride ferroelectric polymer which has a reduced dielectric constant modified by double bonds, so that the overall concentration of a polarized region remains unchanged while an electrocaloric effect is improved under a low electric field. In the present invention, double bonds are generated by means of chemically modifying a polyvinylidene fluoride copolymer which contains a chlorine element, and the method has the advantages of a simple process, a short preparation period, mild reaction conditions, low costs, etc. The prepared polymer thin film has good uniformity and compactness, and is able to achieve an electrocaloric effect adiabatic temperature change of more than 5 degrees Celsius under a low electric field of 50 MV/m, and ensure a long life and stable operations, thus meeting requirements of the industrialization of electrocaloric refrigeration materials and the application of related refrigeration systems.

### TECHNICAL FIELD

The present invention relates to the technical field of all-solid-state refrigeration and, in particular, to a method for modifying a polyvinylidene fluoride-based ferroelectric polymer material and an application thereof. The present invention has broad application prospects and other groups can be introduced as a reference to achieve similar effects. For example, small substituent groups, polar groups, and flexible groups can be introduced to reduce the symmetry and regularity of the main chain, and nucleation impurities such as free radicals can be introduced to reduce the grain size and increase the crystallinity. In this way, it is expected to obtain materials with higher electrocaloric effect.

### DESCRIPTION OF RELATED ART

P(VDF-TrFE-CFE), a polyvinylidene fluoride-based polymer material, is one of the most widely studied and best-performing electrocaloric refrigeration materials. This material can produce a large reversible isothermal entropy change through the order-disorder reversible transformation of dipoles under an electric field. Polyvinylidene fluoride (PVDF) is a typical semi-crystalline polymer, in which the β-type crystal molecular chain orientation is planar serrated, and the-CF₂ dipoles are in the same direction, showing a large spontaneous polarization and high piezoelectric ferroelectricity. By introducing a second monomer trifluoroethylene (TrFE) into a PVDF molecular chain, and based on the steric effect, the P(VDF-TrFE) polymer is induced to directly generate a β phase, thereby achieving better piezoelectric ferroelectricity than a pure PVDF polymer. In order to further reduce the Curie temperature of the material and reduce polarization loss, a third component chlorofluoroethylene or trifluorochloroethylene is further introduced into P(VDF-TrFE), so that the terpolymer exhibits ferroelectric relaxation. Therefore, the ternary polymer shows good electrocaloric properties in a wide temperature range near room temperature.

However, the polyvinylidene fluoride polymers reported so far all require a large electric field to stimulate their electrocaloric properties. Under a large electric field, the materials are very prone to fatigue and cannot meet the basic requirements for stable operation in actual devices. For example, the electric field intensity should be greater than 100 MV/m to achieve an electrocaloric effect with temperature change of greater than 5 K. For example, X. Li reported that P(VDF-TrFE-CFE) (59.2/33.6/7.2 mol %) produced an entropy change of 35 J/kg. K under an electric field intensity change of 100 MV/m at room temperature, corresponding to an adiabatic temperature change of about 7K (Appl. Phys. Lett. 99, 052907(2011 )). This result was subsequently verified by Guo et al., (Appl. Phys. Lett. 105, 031906(2014 )) and Jia et al. (Appl. Phys. Lett. 104, 251913(2014)). However, the high electric field of 100 MV/m is close to the breakdown electric field of a material and easily introduces dielectric fatigue, thus greatly reducing the electrical stability and cycle life of the material, and also limiting the large-scale refrigeration application of electrocaloric polymer materials in chips, electronic devices and other equipment. At present, there is no material with large electrocaloric effect (temperature change of greater than 5K) that can be stably cycled for more than one million times in the art.

To ensure the stable operation of electric field-driven field effect devices, generally, the stable circulating electric field of dielectrics should be about 20% of the actual breakdown electric field of the device. Therefore, the practical application of electrocaloric refrigeration materials requires that electrocaloric polymers can produce usable electrocaloric effects (temperature change of greater than 5K) near an electric field of 50 MV/m. However, the electrocaloric effect (temperature change) of the best electrocaloric polymer materials at present is only about 2K under a low electric field of 50 MV/m. In order to achieve the temperature change of 5K required by electrocaloric refrigeration devices, it is generally necessary to apply an electric field intensity of greater than 80 MV/m, which is close to the breakdown field intensity of the material. Within 3000 cycles, the material has obvious fatigue and can hardly be used in engineering applications.

### BRIEF SUMMARY OF THE INVENTION

In view of the defects of the prior art for improving the electrocaloric effect of polymer materials, which involves complicated process and too many reaction steps, the present invention provides a method for modifying low electric field refrigeration performance of polyvinylidene fluoride ferroelectric polymer and an application thereof, with mild preparation conditions, simple process, low cost and high reliability. Under the induction of a low electric field, the material can generate huge entropy change and electrocaloric effect. The spatial crystal state of the molecule is changed, the volume of the nano-polarized domain is reduced at the microscopic level, and the overall crystallinity of the material is improved; the dielectric constant is reduced at the macroscopic level, and the electrocaloric effect under a low electric field is improved. The material can achieve high isothermal entropy change and adiabatic temperature change under a low electric field, showing excellent refrigeration efficiency.

The present invention is implemented by the following technical solution:

The present invention relates to a method for improving the low-field electrocaloric effect of a polyvinylidene fluoride-based ferroelectric polymer, where a polyvinylidene fluoride-based multipolymer solution reacts with an organic base to obtain a double-bond-modified polyvinylidene fluoride-based ferroelectric polymer with a reduced dielectric constant, achieving the improvement of the electrocaloric effect under a low electric field and keeping the overall concentration of the polarized domain unchanged.

The polyvinylidene fluoride-based multipolymer is a polyvinylidene fluoride-based bipolymer or terpolymer and has a general chemical formula of P (first monomer_{z}-second monomer_{1-z}) or P (first monomerₓ-second monomer_{y}-third monomer_{1-x-y}), wherein the value of Z preferably ranges from 0.60 to 0.90, more preferably from 0.70 to 0.80, the value of X preferably ranges from 0.50 to 0.75, more preferably from 0.55 to 0.65, and the value of Y preferably ranges from 0.25 to 0.40, more preferably from 0.30 to 0.35.

In the bipolymer, the first monomer is vinylidene fluoride (VDF), and the second monomer is chlorofluoroethylene (CFE), difluorochloroethylene (CDFE) or trifluorochloroethylene (CTFE); the corresponding polyvinylidene fluoride-based bipolymer is preferably polyvinylidene fluoride-chlorofluoroethylene P(VDF-CFE), polyvinylidene fluoride-difluorochloroethylene P(VDF-CDFE), polyvinylidene fluoride-trifluorochloroethylene P(VDF-CTFE) or a combination thereof.

In the terpolymer, the first monomeris vinylidene fluoride (VDF), the second monomer is trifluoroethylene (TrFE) or tetrafluoroethylene (TFE), and the third monomer is chlorofluoroethylene (CFE), difluorochloroethylene (CDFE) or trifluorochloroethylene (CTFE); the corresponding polyvinylidene fluoride-based terpolymer is preferably polyvinylidene fluoride-trifluoroethylene-chlorofluoroethylene P(VDF-TrFE-CFE), polyvinylidene fluoride-trifluoroethylene-difluorochloroethylene P(VDF-TrFE-CDFE), polyvinylidene fluoride-trifluoroethylene-trifluorochloroethylene P(VDF-TrFE-CTFE), polyvinylidene fluoride-tetrafluoroethylene-chlorofluoroethylene P(VDF-TFE-CFE), polyvinylidene fluoride-tetrafluoroethylene-difluorochloroethylene P(VDF-TFE-CDFE), polyvinylidene fluoride-tetrafluoroethylene-trifluorochloroethylene P(VDF-TFE-CTFE) or a combination thereof.

The polyvinylidene fluoride-based multipolymer solution is preferably obtained by: in the presence of nitrogen, completely dissolving a polyvinylidene fluoride-based multipolymer in an organic solvent at room temperature.

The organic solvent used in the polyvinylidene fluoride-based multipolymer solution is preferably N-methylpyrrolidone (NMP), N,N-dimethylformamide (DMF), dimethyl sulfoxide (DMSO), acetone, tetrahydrofuran (THF) or a combination thereof.

The organic base is preferably triethylamine, diethylamine, di-n-propylamine, hexamethylenetetramine, tri-n-butylamine or a combination thereof.

The reaction is implemented by: adding the organic base dropwise to the polyvinylidene fluoride-based multipolymer solution, slowly heating the solution to 40-70° C., stirring the solution to have a reaction for 15 min to 24 h, cooling the reaction solution naturally to room temperature, and then adding the reaction solution dropwise to a mixed solution of ethanol and water to precipitate, thus obtaining a modified multipolymer.

The volume ratio of ethanol to water in the mixed solvent is 1:3 to 3:1.

The precipitating is preferably implemented by completely dissolving the target product in acetone, and then reprecipitating the target product three times in the mixed solution of ethanol and water to finally obtain a double-bond-modified polyvinyl fluoride-based ferroelectric polymer.

The volume ratio of the acetone to the mixed solvent of ethanol and water is 1:50 to 1:200, preferably 1:100 to 1:150.

The proportion of double bond modification on the long chain of the double-bond-modified polyvinyl fluoride-based ferroelectric polymer can be flexibly controlled by adjusting the type and amount of the organic base involved in the reaction, as well as the reaction time.

The present invention relates to a modified polyvinyl fluoride-based ferroelectric polymer prepared by the method described above, which is a light yellow solid and generates an entropy change of at least 30 J/kg. K and an adiabatic temperature change of at least 6K under an electric field change of 50 MV/m.

The present invention relates to an application of the modified polyvinylidene fluoride-based ferroelectric polymer material in preparation of an electrocaloric film with a low-field electrocaloric effect. Specifically, the modified polyvinylidene fluoride-based ferroelectric polymer material is used to prepare a precursor sol, which is prepared into the electrocaloric film by drip coating.

The precursor sol is obtained by completely dissolving the modified polymer in N, N-dimethylformamide (DMF) at room temperature.

The drip coating is implemented by: dripping the precursor sol on a quartz glass substrate and evenly spreading the precursor sol to form a liquid film, and then drying the liquid film.

The drying is implemented by heating the liquid film to 100-120° C., preferably for at least 5-24 h, and then slowly cooling the film together with the furnace to room temperature.

### Technical Effect

The present invention solves the problem that the electrocaloric polymer material cannot achieve a temperature change of at least 5° C. under an electric field of 50 MV/m under a low-electric-field practical condition, that is, the electrocaloric polymer material has a detect of low electrocaloric effect. The present invention further improves the crystallization and electrical properties of the polymer by removing HCl from the polyvinylidene fluoride-based multipolymer and introducing a double bond structure to the polymer main chain. The multipolymer produces an entropy change of greater than 30J/kg. K and an adiabatic temperature change of greater than 6K (relative to the temperature change of 1-2K of ordinary multipolymers) under an electric field change of 50 MV/m, which are significantly higher than the performance of all reported electrocaloric materials under the same conditions.

The present invention introduces a double bond structure to the polyvinylidene fluoride polymer main chain through a chemical reduction reaction, changes the lattice strain energy of the molecule in the film, and further changes the spatial crystal state of the molecule. The volume of the nano-polarized domain is reduced at the microscopic level, and the overall crystallinity of the material is improved; the dielectric constant is reduced at the macroscopic level, and the electrocaloric effect under a low electric field is improved. Compared with the traditional modification method where the electrocaloric effect under a high electric field is improved as the dielectric constant increases, the method of the present invention can achieve a great electrocaloric effect under a low electric field (with temperature change of greater than 5K). This method has broad application prospects, and other groups can be introduced as a reference to achieve similar effects. For example, small substituent groups, polar groups, and flexible groups can be introduced to reduce the symmetry and regularity of the main chain, and nucleation impurities such as free radicals can be introduced to reduce the grain size and increase the crystallinity. In this way, it is expected to obtain materials with higher electrocaloric effect.

### BRIEF DESCRIPTION OF THE SEVERAL VIEWS OF THE DRAWINGS

FIG. 1 is an NMR spectrum of a P(VDF-TrFE-CFE) modified polymer, with a double-bond characteristic peak appearing at a chemical shift of 6.5;

FIG. 2 shows the adiabatic temperature change of the polymer before and after P(VDF-TrFE-CFE) modification as a function of electric field intensity; as can be seen, in the range of adiabatic temperature change being greater than 5K and electric field intensity being less than 60MV/m, the polymer has a large adiabatic temperature change;

FIG. 3 shows changes of the dielectric constant and dielectric loss of the polymer before and after P(VDF-TrFE-CFE) modification as a function of electric field intensity; as can be seen, the modified terpolymer has a lower dielectric constant and dielectric loss, and an obvious ferroelectric peak appears, indicating that the ferroelectric phase content increases; and

FIG. 4 is an XRD spectrum of the polymer before and after P(VDF-TrFE-CFE) modification, as can be seen, the modified polymer has a wider diffraction peak, indicating that the grain size of the material becomes smaller.

### DETAILED DESCRIPTION OF THE INVENTION

### Example 1

### Preparation of Modified polyvinylidene fluoride-chlorofluoroethylene bipolymer

This example includes the following steps: 1 g of polyvinylidene fluoride-chlorofluoroethylene P(VDF-CFE) (60/40 mol %) bipolymer was placed in a water-free and oxygen-free double-mouth round-bottom flask; gas replacement was then performed for three times; acetone solvent was then added in the presence of nitrogen to completely dissolve the polymer at room temperature; 4.0 mL of hexamethylenetetramine was then added dropwise to the reaction system, and the reaction system was then slowly heated to 40° C. and stirred to react for 2 h; after the reaction, the reaction system was slowly cooled to room temperature and then added dropwise to a mixed solution of ethanol and water (v/v: 1:1) to precipitate to obtain a modified multipolymer; the dissolution and washing operation was repeated three times to finally obtain a double-bond-modified P(VDF-CFE) ferroelectric polymer. The test shows that the polymer can generate a temperature change of 4.1K under an electric field intensity change of 50 MV/m.

### Example 2

### Preparation of Modified polyvinylidene fluoride-chlorodifluoroethylene bipolymer

This example includes the following steps: 1 g of polyvinylidene fluoride-chlorofluoroethylene P(VDF-CDFE) (66/34 mol %) bipolymer was placed in a water-free and oxygen-free double-mouth round-bottom flask; gas replacement was then performed for three times; N-methylpyrrolidone (NMP) solvent was then added in the presence of nitrogen to completely dissolve the polymer at room temperature; 3.5 mL of diethylamine was then added dropwise to the reaction system, and the reaction system was then slowly heated to 60° C. and stirred to react for 45 min; after the reaction, the reaction system was slowly cooled to room temperature and then added dropwise to a mixed solution of ethanol and water (v/v: 1.5:1) to precipitate to obtain a modified multipolymer; the dissolution and washing operation was repeated three times to finally obtain a double-bond-modified P(VDF-CDFE) ferroelectric polymer. The test shows that the polymer can generate a temperature change of 6.3K under an electric field intensity change of 50 MV/m.

### Example 3

### Preparation of Modified polyvinylidene fluoride-hlorotrifluoroethylene bipolymer

This example includes the following steps: 1 g of polyvinylidene fluoride-chlorofluoroethylene P(VDF-CTFE) (56/44 mol %) bipolymer was placed in a water-free and oxygen-free double-mouth round-bottom flask; gas replacement was then performed for three times; N, N-dimethylformamide (DMF) solvent was then added in the presence of nitrogen to completely dissolve the polymer at room temperature; 4.2 mL of di-n-propylamine was then added dropwise to the reaction system, and the reaction system was then slowly heated to 55° C. and stirred to react for 1.5 h; after the reaction, the reaction system was slowly cooled to room temperature and then added dropwise to a mixed solution of ethanol and water (v/v: 2:1) to precipitate to obtain a modified multipolymer; the dissolution and washing operation was repeated three times to finally obtain a double-bond-modified P(VDF-CTFE) ferroelectric polymer. The test shows that the polymer can generate a temperature change of 7.5K under an electric field intensity change of 50 MV/m.

### Example 4

### Preparation of Modified polyvinylidene fluoride-trifluoroethylene-chlorofluoroethylene terpolymer

This example includes the following steps: 1 g of polyvinylidene fluoride-trifluoroethylene-chlorofluoroethylene P(VDF-TrFE-CFE) (60.5/32.5/7.0 mol %) terpolymer was placed in a water-free and oxygen-free double-mouth round-bottom flask; gas replacement was then performed for three times; N, N-dimethylformamide (DMF) solvent was then added in the presence of nitrogen to completely dissolve the polymer at room temperature; 3.6 mL of triethylamine was then added dropwise to the reaction system, and the reaction system was then slowly heated to 60° C. and stirred to react for 1 h; after the reaction, the reaction system was slowly cooled to room temperature and then added dropwise to a mixed solution of ethanol and water (v/v: 2:1) to precipitate to obtain a modified multipolymer; the dissolution and washing operation was repeated three times to finally obtain a double-bond-modified P(VDF-TrFE-CFE) ferroelectric polymer. The test shows that the polymer can generate a temperature change of 8.0K under an electric field intensity change of 50 MV/m.

### Example 5

### Preparation of Modified polyvinylidene fluoride-trifluoroethylene-chlorodifluoroethylene terpolymer

This example includes the following steps: 1 g of polyvinylidene fluoride-trifluoroethylene-chlorodifluoroethylene P(VDF-TrFE-CDFE) (59.2/33.6/7.2 mol %) terpolymer was placed in a water-free and oxygen-free double-mouth round-bottom flask; gas replacement was then performed for three times; acetone solvent was then added in the presence of nitrogen to completely dissolve the polymer at room temperature; 4.6 mL of N,N-dimethylformamide was then added dropwise to the reaction system, and the reaction system was then slowly heated to 70° C. and stirred to react for 45 min; after the reaction, the reaction system was slowly cooled to room temperature and then added dropwise to a mixed solution of ethanol and water (v/v: 1:2) to precipitate to obtain a modified multipolymer; the dissolution and washing operation was repeated three times to finally obtain a double-bond-modified P(VDF-TrFE-CDFE) ferroelectric polymer. The test shows that the polymer can generate a temperature change of 5.3K under an electric field intensity change of 50 MV/m.

### Example 6

### Preparation of Modified polyvinylidene fluoride-trifluoroethylene-chlorotrifluoroethylene terpolymer

This example includes the following steps: 1 g of polyvinylidene fluoride-trifluoroethylene-chlorotrifluoroethylene P(VDF-TrFE-CTFE) (69.7/30.3/6.0 mol %) terpolymer was placed in a water-free and oxygen-free double-mouth round-bottom flask; gas replacement was then performed for three times; tetrahydrofuran solvent was then added in the presence of nitrogen to completely dissolve the polymer at room temperature; 2.8 mL of tri-n-butylamine was then added dropwise to the reaction system, and the reaction system was then slowly heated to 55° C. and stirred to react for 4 h; after the reaction, the reaction system was slowly cooled to room temperature and then added dropwise to a mixed solution of ethanol and water (v/v: 1:2) to precipitate to obtain a modified multipolymer; the dissolution and washing operation was repeated three times to finally obtain a double-bond-modified P(VDF-TrFE-CFE) ferroelectric polymer. The test shows that the polymer can generate a temperature change of 4.5K under an electric field intensity change of 50 MV/m.

### Example 7

### Preparation of Modified polyvinylidene fluoride-tetrafluoroethylene-chlorofluoroethylene terpolymer

This example includes the following steps: 1 g of polyvinylidene fluoride-tetrafluoroethylene-chlorofluoroethylene P(VDF-TFE-CFE) (64.5/30.5/4.9 mol %) terpolymer was placed in a water-free and oxygen-free double-mouth round-bottom flask; gas replacement was then performed for three times; acetone solvent was then added in the presence of nitrogen to completely dissolve the polymer at room temperature; 4.5 mL of hexamethylenetetramine was then added dropwise to the reaction system, and the reaction system was then slowly heated to 65° C. and stirred to react for 1 h; after the reaction, the reaction system was slowly cooled to room temperature and then added dropwise to a mixed solution of ethanol and water (v/v: 2:1) to precipitate to obtain a modified multipolymer; the dissolution and washing operation was repeated three times to finally obtain a double-bond-modified P(VDF-TFE-CFE) ferroelectric polymer. The test shows that the polymer can generate a temperature change of 5.9K under an electric field intensity change of 50 MV/m.

### Example 8

### Preparation of Modified polyvinylidene fluoride-tetrafluoroethylene-chlorodifluoroethylene terpolymer

This example includes the following steps: 1 g of polyvinylidene fluoride-tetrafluoroethylene-chlorodifluoroethylene P(VDF-TFE-CDFE) (58.5/35.5/6.0 mol %) terpolymer was placed in a water-free and oxygen-free double-mouth round-bottom flask; gas replacement was then performed for three times; acetone solvent was then added in the presence of nitrogen to completely dissolve the polymer at room temperature; 4.0 mL of triethylamine was then added dropwise to the reaction system, and the reaction system was then slowly heated to 55° C. and stirred to react for 2 h; after the reaction, the reaction system was slowly cooled to room temperature and then added dropwise to a mixed solution of ethanol and water (v/v: 3:1) to precipitate to obtain a modified multipolymer; the dissolution and washing operation was repeated three times to finally obtain a double-bond-modified P(VDF-TFE-CDFE) ferroelectric polymer. The test shows that the polymer can generate a temperature change of 6.7K under an electric field intensity change of 50 MV/m.

### Example 9

### Preparation of Modified polyvinylidene fluoride-tetrafluoroethylene-chlorotrifluoroethylene terpolymer

This example includes the following steps: 1 g of polyvinylidene fluoride-tetrafluoroethylene-chlorotrifluoroethylene P(VDF-TFE-CTFE) (64.5/30.5/4.9 mol %) terpolymer was placed in a water-free and oxygen-free double-mouth round-bottom flask; gas replacement was then performed for three times; dimethyl sulfoxide solvent was then added in the presence of nitrogen to completely dissolve the polymer at room temperature; 2.5 mL of di-n-propylamine was then added dropwise to the reaction system, and the reaction system was then slowly heated to 70° C. and stirred to react for 40 min; after the reaction, the reaction system was slowly cooled to room temperature and then added dropwise to a mixed solution of ethanol and water (v/v: 1:3) to precipitate to obtain a modified multipolymer; the dissolution and washing operation was repeated three times to finally obtain a double-bond-modified P(VDF-TFE-CTFE) ferroelectric polymer. The test shows that the polymer can generate a temperature change of 7.4K under an electric field intensity change of 50 MV/m.

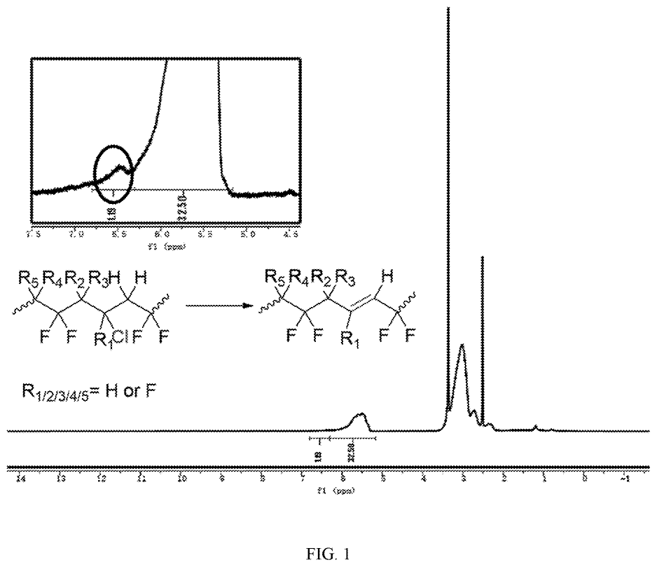

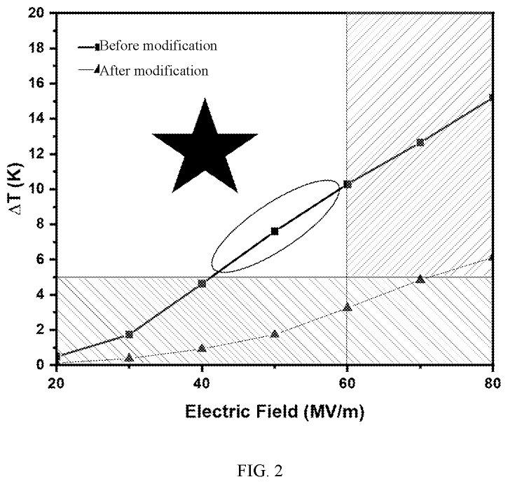

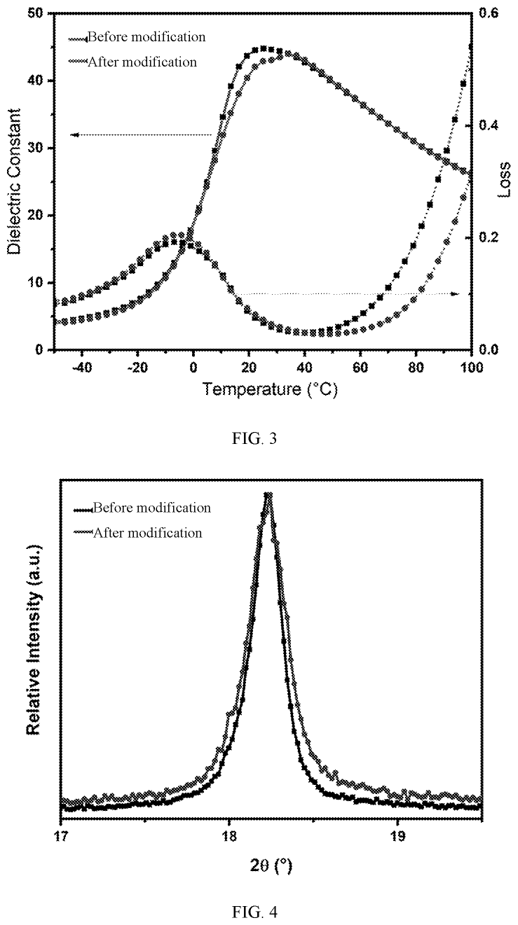

The double-bond-modified polyvinylidene fluoride-trifluoroethylene-chlorofluoroethylene terpolymer of Example 4 was structurally characterized by nuclear magnetic resonance, and the nuclear magnetic resonance spectrum was shown in FIG. 1. The modified polymer prepared in Example 4 was tested for electrocaloric properties, and the variation law of its electrocaloric effect adiabatic temperature change with temperature was obtained. As shown in FIG. 2. the modified polyvinylidene fluoride copolymer has a large adiabatic temperature change within the range of adiabatic temperature change being greater than 5 K and electric field intensity being less than 60 MV/m. The test shows changes of the dielectric constant and dielectric loss of the modified polymer prepared in Example 4 as a function of electric field intensity. As shown in FIG. 3, the modified terpolymer has a lower dielectric constant and dielectric loss, and an obvious ferroelectric peak appears, indicating that the ferroelectric phase content increases. FIG. 4 is an XRD spectrum of the modified polymer. The modified polymer has a wider diffraction peak, indicating that the grain size of the material becomes smaller. The above characterizations all indicate that the ferroelectric polymer material modified by this method has more excellent electrocaloric properties.

Compared with the prior art, the material modified by this method generates an entropy change of 30-45 J/kg. K and an adiabatic temperature change of 5-9 K under an electric field change of 50 MV/m. The volume of the nano-polarized domain is reduced at the microscopic level, and the overall crystallinity of the material is improved; the dielectric constant is reduced at the macroscopic level, and the electrocaloric effect under a low electric field is improved. Among all the polyvinylidene fluoride-based ferroelectric polymers reported so far, the material modified by this method has highest refrigeration efficiency (refrigeration energy/electric field energy) and electrocaloric refrigeration intensity (temperature change/electric field intensity) under a low electric field.

The aforementioned method for the chemical modification of chlorine-containing polyvinylidene fluoride copolymers-specifically, the technique for generating double bonds-is an original innovation of the present invention. Compared with existing conventional technical approaches, it offers numerous advantages, including a simple process, a short preparation cycle, mild reaction conditions, and low cost; furthermore, the resulting polymer films exhibit excellent uniformity and compactness.

The specific embodiments described above can be partially adjusted in different ways by those skilled in the art without departing from the principle and purpose of the invention. The scope of the invention shall be subject to the claims and shall not be limited by the specific embodiments described above. All implementation solutions within its scope shall be subject to the constraints of the invention.

1-10. (canceled)

11. A method for improving the low-field electrocaloric effect of a polyvinylidene fluoride-based ferroelectric polymer, wherein a polyvinylidene fluoride-based multipolymer solution reacts with an organic base to obtain a double-bond-modified polyvinylidene fluoride-based ferroelectric polymer, thereby achieving the improvement of the electrocaloric effect under a low electric field;
the polyvinylidene fluoride-based multipolymer is a polyvinylidene fluoride-based bipolymer or a polyvinylidene fluoride-based terpolymer and has a general chemical formula of P(first monomer_{z}-second monomer_{1-z}) or P(first monomerₓ-second monomer_{y}-third monomer_{1-x-y}), wherein
in the bipolymer, the first monomer is vinylidene fluoride (VDF), the second monomer is chlorofluoroethylene (CFE), chlorodifluoroethylene (CDFE) or chlorotrifluoroethylene (CTFE), and the value of Z ranges from 0.60 to 0.90;
in the terpolymer, the first monomer is vinylidene fluoride (VDF), the second monomer is trifluoroethylene (TrFE) or tetrafluoroethylene (TFE), the third monomer is chlorofluoroethylene (CFE), difluorochloroethylene (CDFE) or trifluorochloroethylene (CTFE), the value of X ranges from 0.50 to 0.75, and the value of Y ranges from 0.25 to 0.40;
the organic base is triethylamine, diethylamine, di-n-propylamine, hexamethylenetetramine, tri-n-butylamine or a combination thereof.

12. The method for improving the low-field electrocaloric effect of a polyvinylidene fluoride-based ferroelectric polymer according to claim 11, wherein the value of x ranges from 0.55 to 0.65, the value of Y ranges from 0.30 to 0.35, and the value of Z ranges from 0.70 to 0.80.

13. The method for improving the low-field electrocaloric effect of a polyvinylidene fluoride-based ferroelectric polymer according to claim 11, wherein the polyvinylidene fluoride-based bipolymer is polyvinylidene fluoride-chlorofluoroethylene P(VDF-CFE), polyvinylidene fluoride-difluorochloroethylene P(VDF-CDFE), polyvinylidene fluoride-trifluorochloroethylene P(VDF-CTFE) or a combination thereof:
the polyvinylidene fluoride-based terpolymer is polyvinylidene fluoride-trifluoroethylene-chlorofluoroethylene P(VDF-TrFE-CFE), polyvinylidene fluoride-trifluoroethylene-difluorochloroethylene P(VDF-TrFE-CDFE), polyvinylidene fluoride-trifluoroethylene-trifluorochloroethylene P(VDF-TrFE-CTFE), polyvinylidene fluoride-tetrafluoroethylene-chlorofluoroethylene P(VDF-TFE-CFE), polyvinylidene fluoride-tetrafluoroethylene-difluorochloroethylene P(VDF-TFE-CDFE), polyvinylidene fluoride-tetrafluoroethylene-trifluorochloroethylene P(VDF-TFE-CTFE) or a combination thereof.

14. The method for improving the low-field electrocaloric effect of a polyvinylidene fluoride-based ferroelectric polymer according to claim 11, wherein the polyvinylidene fluoride-based multipolymer solution is obtained by: in the presence of nitrogen, completely dissolving a polyvinylidene fluoride-based multipolymer in an organic solvent at room temperature;
the organic solvent used in the polyvinylidene fluoride-based multipolymer solution is N-methylpyrrolidone (NMP), N, N-dimethylformamide (DMF), dimethyl sulfoxide (DMSO), acetone, tetrahydrofuran (THF) or a combination thereof.

15. The method for improving the low-field electrocaloric effect of a polyvinylidene fluoride-based ferroelectric polymer according to claim 11, wherein the reaction is implemented by: adding the organic base dropwise to the polyvinylidene fluoride-based multipolymer solution, slowly heating the solution to 40-70° C., stirring the solution to have a reaction for 15 min to 24 h, cooling the reaction solution naturally to room temperature, and then adding the reaction solution dropwise to a mixed solution of ethanol and water to precipitate, thus obtaining a modified multipolymer.

16. The method for improving the low-field electrocaloric effect of a polyvinylidene fluoride-based ferroelectric polymer according to claim 15, wherein the volume ratio of ethanol to water in the mixed solvent is 1:3 to 3:1.

17. The method for improving the low-field electrocaloric effect of a polyvinylidene fluoride-based ferroelectric polymer according to claim 15, wherein the precipitating is implemented by completely dissolving a target product in acetone, and then reprecipitating the target product three times in the mixed solution of ethanol and water to finally obtain a double-bond-modified polyvinyl fluoride-based ferroelectric polymer.

18. The method for improving the low-field electrocaloric effect of a polyvinylidene fluoride-based ferroelectric polymer according to claim 17, wherein the volume ratio of the acetone to the mixed solvent of ethanol and water is 1:50 to 1:200.

19. A modified polyvinylidene fluoride-based ferroelectric polymer, prepared by the method according to claim 11.

20. The modified polyvinyl fluoride-based ferroelectric polymer according to claim 19, wherein the modified polyvinyl fluoride-based ferroelectric polymer generates an entropy change of at least 30 J/kg. K and an adiabatic temperature change of at least 6K under an electric field change of 50 MV/m.
